(19) United States
(12) Patent Application Publication
(10) Pub. No.: US 2013/0001471 A1
(43) Pub. Date: Jan. 3, 2013

(54) CORE-SHELL PHOSPHOR AND METHOD OF MAKING THE SAME

(75) Inventors: Alok Mani Srivastava, Niskayuna, NY (US); Holly Ann Comanzo, Niskayuna, NY (US); Samuel Joseph Camardello, Albany, NY (US); Florencio Garcia, Schenectady, NY (US)

(73) Assignee: GENERAL ELECTRIC COMPANY, SCHENECTADY, NY (US)

(21) Appl. No.: 13/171,073

(22) Filed: Jun. 28, 2011

(51) Int. Cl. C09K 11/81; B05D 5/06

(52) U.S. Cl. 252/301.6 P; 252/301.4 P; 427/162

(57) ABSTRACT

In accordance with one aspect of the present invention, a core-shell phosphor composition is provided that includes a core comprising at least one material selected from the group consisting of aluminum phosphate, gallium phosphate, calcium phosphate, magnesium phosphate, zinc phosphate and boron phosphate; and a shell at least partially enclosing the core, wherein the shell comprises a shell material having formula (I)

La_{1-x-y}CeₓTb_{y}PO₄ (I)

wherein, 0<x<0.95, and 0<y<0.5. In accordance to another aspect of the invention a method of making the core-shell phosphor and a light source including the core-shell phosphor are provided.

### BACKGROUND

The invention generally relates to a core-shell phosphor. More particularly, the invention relates to a core-shell phosphor composition and a method for making the core-shell phosphor.

Mixed phosphates of lanthanum and/or cerium, doped with terbium (usual acronym “LAP”), are well-known phosphor compositions. A LaPO₄:Ce, Tb phosphor composition is known as green phosphor (LAP) as it emits a bright green light when it is irradiated by certain high-energy radiation having wavelengths below the visible range. This property is advantageously used on an industrial scale, for example, in trichromatic fluorescent lamps, backlighting systems for liquid crystal displays and in plasma systems.

Various synthesis methods have been developed to maximize the efficiency of LAP phosphor. Some of the synthesis methods improve crystallinity of LAP phosphor thereby enhancing the efficiency. Some other synthesis methods optimize the particle size distribution and morphology of phosphor particles in order to get a uniform coating during lamp coating.

However, a problem still unaddressed is of their particularly high cost, linked especially to the use of rare earths such as lanthanum, cerium and terbium. Hence, it is desirable to develop core-shell phosphors to meet the existing need for inexpensive, high quality phosphors. Coating of relatively inexpensive core with expensive shell materials can help lower the cost of phosphor as well as the cost of manufacturing fluorescent lamps.

### BRIEF DESCRIPTION

In accordance with one aspect of the present invention, a core-shell phosphor composition is provided that includes a core comprising at least one material selected from the group consisting of aluminum phosphate, gallium phosphate, calcium phosphate, magnesium phosphate, zinc phosphate and boron phosphate; and a shell at least partially enclosing the core, wherein the shell comprises a shell material having formula (I)

La_{1-x-y}CeₓTb_{y}PO₄ (I)

wherein, 0<x<0.95, and 0<y<0.5.

In accordance with another aspect, the present invention provides a method of making a core-shell phosphor. The method includes the steps of (a) mixing an aluminum phosphate core material with a shell precursor mixture comprising at least one compound of La, at least one compound of Ce, and at least one compound of Tb to form a core+shell precursor mixture; (b) heating the core+shell precursor mixture to a temperature in a range from about 800° C. to about 1200° C. with an inorganic flux material to provide a heated core+shell precursor mixture; (c) cooling the heated core+shell precursor mixture to ambient temperature to provide a product core-shell phosphor dispersed in the inorganic flux material; and (d) separating the product core-shell phosphor from the inorganic flux material.

In accordance with one aspect of the present invention, a core-shell phosphor composition is provided that includes a core comprising aluminum phosphate; and a shell at least partially enclosing the core, wherein the shell comprises a shell material having formula (I)

La_{1-x-y}CeₓTb_{y}PO₄ (I)

wherein, 0<x<0.95, and 0<y<0.5.

In accordance with yet another aspect, the present invention provides a light source comprising a core-shell phosphor. The core-shell phosphor composition includes a core comprising at least one material selected from the group consisting of aluminum phosphate, gallium phosphate, calcium phosphate, magnesium phosphate, zinc phosphate and boron phosphate; and a shell at least partially enclosing the core, wherein the shell comprises a shell material having formula (I)

La_{1-x-y}CeₓTb_{y}PO₄ (I)

wherein, 0<x<0.95, and 0<y<0.5.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

It is also understood that terms such as “top,” “bottom,” “outward,” “inward,” and the like are words of convenience and are not to be construed as limiting terms. Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the term “longest dimension” refers to the longest Euclidean distance between two points in a particle. For example, if the particle is spherical, the diameter is the longest dimension of the particle. For an elliptical particle, the longest dimension is the major axis of the ellipse. In hydrated form, the longest dimension of a spherical particle may be the mean or average hydrodynamic diameter of the particle. Similarly, a phosphor particle having a dimension of 1 μm refers to a phosphor particle that has a longest dimension of at least 1 μm. For a phosphor particle of irregular geometry, the size of the particle may be described in terms of its dimension, the longest Euclidean distance between two points in the particle.

As discussed in detail below, embodiments of the present invention include a core-shell phosphor composition that includes a core comprising at least one material selected from the group consisting of aluminum phosphate, gallium phosphate, calcium phosphate, magnesium phosphate, zinc phosphate and boron phosphate; and a shell at least partially enclosing the core, wherein the shell comprises a shell material having formula (I)

La_{1-x-y}CeₓTb_{y}PO₄ (I)

wherein, 0<x<0.95, and 0<y<0.5.

As noted, the core provided by the present invention comprises at least one compound of aluminum, gallium, calcium, magnesium, zinc and boron which is a temperature-stable material. As used herein, the term “temperature stable material” refers to a material having a melting point at high temperature, and the material does not degrade into a by-product affecting the application, for example an application of phosphor, at the same temperature. The material remains crystalline without converting into an amorphous material at the same temperature. The high temperature proposed here is a temperature of at least greater than 900° C., particularly at least greater than 1000° C. The core of the present invention comprises at least one material selected from the group consisting of aluminum phosphate, gallium phosphate, calcium phosphate, magnesium phosphate, zinc phosphate and boron phosphate. In one embodiment, the core comprises an aluminum phosphate. In one embodiment, the core may be substantially free of lanthanum. In another embodiment, the core may contain less than about 1000 ppm of lanthanum. In one embodiment, the core may be also include a mineral oxide, for example, an aluminum oxide. In some embodiments, the core may comprise trace amounts of one or more rare earth metals, such as cerium, terbium, gadolinium, scandium, yttrium, or combinations thereof.

Typically, the core is at least partially enclosed by a shell. In various embodiments, on the surface of the core, a layer or shell based on a material of mixed La and/or Ce-phosphate, doped with Tb may be deposited. The deposited material is known as a shell, which is made of a mixed LAP phosphate (La, Ce, Tb) PO₄ and which at least partially encloses the core. In another embodiment, the shell is a homogeneous layer of a mixed LAP phosphate that coherently crystallizes on the core. As used herein, the term “homogeneous layer” refers to a continuous layer, completely covering the core, and the homogeneity is clearly visible on scanning electron micrographs. The material of the layer has a homogeneous distribution.

The shell comprises a shell material having formula (I)

La_{1-x-y}CeₓTb_{y}PO₄ (I)

wherein, 0<x<0.95, and 0<y<0.5. In one embodiment, the value of x is in a range from about 0.05 to about 0.90, the value of y is in a range from about 0.05 to about 0.5, and (x+y) is less than about 1. In certain embodiments, for the shell of formula (I), the value of x is in a range from about 0.1 to about 0.5, the value of y is in a range from about 0.1 to about 0.4, and (x+y) is less than or equal to about 1. In certain specific embodiments, for the shell of formula (I), the value of x is in a range from about greater than 0 to about 0.5 (0<x0.5), and the value of y is in a range from about greater than 0 to about 0.5 (0<y0.5). According to shell of the invention, the sum (x+y) is less than 1, so that the compound of formula (I) contains at least certain amount of lanthanum. In one embodiment, x is between 0.05 and 0.3, and y is between 0.05 and 0.6. In another embodiment, x is between 0.1 and 0.5; y is between 0.1 and 0.3; and the sum (x+y) is between 0.2 and 0.8. In one embodiment, an atom percent of La in the shell is in a range from about 0% to about 60%. In another embodiment, an atom percent of La in the shell is in a range from about 5% to about 45%. In one embodiment, an atom percent of Ce in the shell is in a range from about 10% to about 100%. In another embodiment, an atom percent of Ce in the shell is in a range from about 20% to about 75%.

In another non-limiting example, the shell composition consists essentially of La_{0.6}Ce_{0.27}Tb_{0.13}PO_{4.} In one embodiment, the phosphor is a gradient core-shell phosphor, where Tb is used as an activator. The phosphor is configured to maintain an optimal concentration of the activator on the surface and lowering the concentration at the core. Therefore, the phosphor results in a reduction of an amount of Tb in the phosphor. In one embodiment, an atom percent of Tb in the shell is in a range from about 1% to about 20%. In another embodiment, an atom percent of Tb in the shell is in a range from about 1% to about 13%. In a specific embodiment, an atom percent of Tb in the shell is less than about 10%.

The shell material (La, Ce, Tb)PO₄ may further comprise other compounds, for example, polyphosphates of rare-earth metals, generally in a minor amount that does not exceed about 5%. According to one particular embodiment, the mixed phosphate, which crystallizes on the core may comprise one or more elements other than La, Ce, or Tb, where the elements conventionally have a role, in particular, of promoting the luminescence properties or of stabilizing the degrees of oxidation of the Ce and Tb. These additional elements may include, for example, alkali metals (Li, Na, K, in particular), thorium and boron.

The core-shell phosphor provided by the present invention comprises a particulate structure. The core-shell phosphor particle may comprise a regular geometry or an irregular geometry. The core-shell phosphor particle may be of various shapes, such as spherical, elliptical, or cubical. The dimensions of the core, shell, and the core-shell particle may especially be measured from scanning electron micrographs of sections of core or shell or core-shell particle.

In some embodiments, the core-shell of the present invention comprises a particulate structure with a longest dimension in a range from about 0.5 μm to about 15 μm. In some embodiments, the core-shell of the present invention comprises a particulate structure with a longest dimension in a range from about 0.5 μm to about 10 μm. In one embodiment, the core-shell phosphor may have a shell of thickness in a range from about 0.25 μm to 5 μm, specifically in a range from about 0.3 μm to about 0.8 μm. In another embodiment, the core-shell phosphor may have a core of thickness in a range from about 0.5 μm to 5 μm. In some embodiments, the core-shell phosphor may have a core having a particulate structure with a longest dimension in a range from about 0.2 μm to about 5 μm.

In certain embodiments, the core-shell phosphor particle may have a longest dimension in a range from about 0.5 μm to about 20 μm. In one embodiment, the core-shell phosphor may have a longest dimension between 1.5 μm and 15 μm. In some embodiments, the core-shell phosphor product may be milled by using ⅛ inch yttria stabilized zirconia (YSZ) media in water in order to break any agglomerates of particle formed and get the desired particle size. This milling may be done for 1-10 minutes as per requirement.

The luminescence property of a phosphor may be quantified by the conversion yield of the phosphor, which corresponds to a ratio of the number of photons emitted by a phosphor to the number of photons absorbed from the excitation beam. The conversion yield of a phosphor is evaluated by measuring, in the visible range of the electromagnetic spectrum, the emission of a phosphor under an excitation in the UV or VUV range generally at a wavelength below 280 nm The value of the brightness obtained for the core-shell phosphor, at emission intensity integrated between 400 and 700 nm, is then compared with that of a reference phosphor. The core-shell phosphor provided by the present invention has intense green luminescence property for electromagnetic excitations corresponding to the various absorption fields of the product. The core-shell phosphor has a strong green emission under VUV excitation, due to strong absorption at these wavelengths by the mixed LAP phosphate, and also by the cerium ions. Thus, the core-shell phosphor may be used in lighting or display systems having an excitation source in the UV range (200-280 nm), for example around 254 nm.

The core-shell phosphor may be used in UV excitation devices, such as in trichromatic lamps, especially in mercury vapor trichromatic lamps, lamps for backlighting liquid crystal systems, plasma screens, xenon excitation lamps, devices for excitation by light-emitting diodes (LEDs), fluorescent lamps, cathode ray tube, plasma display device, liquid crystal display (LCD), and UV excitation marking systems. The core-shell phosphor may also be used as a scintillator in an electromagnetic calorimeter, in a gamma ray camera, in a computed tomography scanner or in a laser. These uses are meant to be merely exemplary and not exhaustive.

In one embodiment, the present invention provides a method of making a core-shell phosphor. The method includes the steps of (a) mixing at least one core material selected from the group consisting of aluminum phosphate, gallium phosphate, calcium phosphate, magnesium phosphate, zinc phosphate and boron phosphate with a shell precursor mixture comprising at least one compound of La, at least one compound of Ce, and at least one compound of Tb to form a core+shell precursor mixture; (b) heating the core+shell precursor mixture to a temperature in a range from about 800° C. to about 1200° C. with an inorganic flux material to provide a heated core+shell precursor mixture; (c) cooling the heated core+shell precursor mixture to ambient temperature to provide a product core-shell phosphor dispersed in the inorganic flux material; and (d) separating the product core-shell phosphor from the inorganic flux material.

Typically at least one compound of La, at least one compound of Ce, and at least one compound of Tb are used to make the shell. In one embodiment, the shell precursor mixture may include starting materials for example, elemental oxides, nitrates, phosphates, carbonates, and/or hydroxides. Other starting materials may include, but are not limited to, sulfates, acetates, citrates, or oxalates. Alternately, co-precipitates or double salts of one or more of rare earth compounds may also be used as the starting materials. As noted, the compound of La, compound of Ce, and compound of Tb, are independently at each occurrence, selected from oxides, nitrates, carbonates, acetates, and combinations thereof. For a non-limiting example, compound of La may be selected from oxides, such as lanthanum-oxide, wherein the compound of Ce and/or the compounds of Tb may be selected from nitrates, such as Ce-nitrate or Tb-nitrate and vice-versa. The compound of La may be selected from carbonate, such as La-carbonate, wherein the compound of Ce and/or compound of Tb may be selected from acetates, such as Ce-acetate or Tb-acetate and vice-versa. In another non-limiting example, compound of La may be selected from oxides, such as La-oxide, wherein the compound of Ce is selected from nitrate, such as Ce-nitrate or ammonium ceric nitrate and the compound of Tb may be selected from acetate, such as Tb-acetate. In another embodiment, the shell precursor mixture comprises at least one compound of La, at least one compound of Ce, and at least one compound of Tb, which are selected from phosphates, such as, La-phosphate, Ce-phosphate, or Tb-phosphate. In yet another embodiment, the shell precursor mixture may comprise a mixed phosphate of La, Ce, and Tb. The lanthanide phosphates may be mixed with AlPO₄ core along with fluxes and heated at 900° C. to form core-shell phosphor.

In one embodiment, the shell precursor mixture further comprises diammonium phosphate ((NH₄)₂HPO₄) (also sometimes herein referred to as DAP). The DAP converts the compound of La, compound of Ce and compound of Tb to their corresponding phosphates in the reaction mixture. The phosphate of La, phosphate of Ce and phosphate of Tb form a mixed LAP phosphate (La, Ce, Tb) PO₄, which is deposited on the core. In one embodiment, for example, the shell precursor mixture comprises DAP, lanthanum oxide (La₂O₃), cerium oxide (Ce₂O₃), and terbium oxide (Tb₄O₇), where DAP converts La₂O₃, Ce₂O₃, and Tb₄O₇ to (La, Ce, Tb) PO₄ which is deposited on the core.

In one embodiment, the core-shell phosphor is made employing a molten salt method where the starting materials (such as LaPO₄, DAP, La₂O₃, Ce₂O₃, Tb₄O₇) may be milled down to micron-sized powders and then dispersed in an inorganic flux material and mixed thoroughly by shaking in a Nalgene bottle. The mixture of reactants and flux materials may be dispensed into an alumina crucible under vigorous mixing. The starting materials may be mixed together by any mechanical method including, but is not limited to, stirring or blending in a high-speed blender or a ribbon blender. In a typical process, the starting materials may be combined via a dry blending process. The starting materials may be combined and pulverized together in a bowl mill, a hammer mill, or a jet mill

In one embodiment, the inorganic flux material may be added to the core+shell precursor mixture prior to or during the mixing step of the reactants. In one embodiment, the inorganic flux material may be selected from one or more of disodium hydrogen phosphate (Na₂HPO₄), sodium dihydrogen phosphate (NaH₂PO₄), sodium diphosphate (Na₄P₂O₇), sodium tetraborate, lithium tetraborate (Li₂B₄O₇), boron trioxide (B₂O₃), and boric acid. In another embodiment, the inorganic flux material is a mixture of Na₂HPO₄, and Li₂B₄O₇. In yet another embodiment, the inorganic flux materials may further include any other conventional fluxing agent, such as aluminum trifluoride (AlF₃), ammonium chloride (NH₄Cl). As the formation of the shell is initiated in the presence of a flux material in a molten phase, a minimum temperature is necessary to maintain the molten state of the inorganic fluxes. In one embodiment, the amount of inorganic flux material is less than about 20%, particularly less than about 10% by weight of the total weight of the mixture. Typically, the heating of the core+shell precursor mixture with the inorganic flux material is carried out at a temperature in a range from about 800° C. to about 1200° C. In one embodiment, the heating of the core+shell precursor mixture with the inorganic flux material is carried out at a temperature in a range from about 900° C. to about 1000° C.

In one embodiment, the heating of the core+shell precursor mixture with the inorganic flux material is carried out in presence of a reducing agent. Typically, the reducing agent comprises a reducing gas such as hydrogen, carbon monoxide, nitrogen, charcoal, or combinations thereof. The reducing agent is optionally diluted with an inert gas, such as nitrogen or Argon, or combinations thereof. In a specific embodiment, the reducing agent may comprise hydrogen, nitrogen, or combinations thereof. In one embodiment, to produce carbon monoxide atmosphere, the crucible containing the core-shell mixture may be packed in a second closed crucible containing high-purity carbon particles and fired in air so that the carbon particles react with the oxygen present in the air, thereby, generating carbon monoxide for providing a reducing atmosphere.

For core-shell phosphors, a homogeneous shell material may be formed after firing the core+shell precursor mixture between about 900° C. to about 950° C. under a reducing atmosphere (e.g. 1% H₂ in N₂). The dried core-shell mixture may be fired under a reducing atmosphere at a temperature from about 900° C. to about 1200° C., or from about 1000° C. to about 1600° C., for a time sufficient to convert all of the mixture to the final composition. As noted, the heating or firing of the core-shell mixture may be conducted in an alumina crucible using a tube furnace. The heating or firing may be conducted in a batch wise or continuous process, with a stirring or mixing action to promote adequate gas-solid contact. The firing time depends on the quantity of the mixture to be fired, the rate of gas conducted through the firing equipment, and the quality of the gas-solid contact in the firing equipment. Typically, a firing time of about 1 hour under reducing atmosphere is adequate for maximum turnover of reactant to product. The combination of fluxes may be chosen in a way to tune the solubility of LaPO₄ or (La,Ce,Tb)PO₄ in order to obtain core-shell phosphor at desired synthesis temperature.

In one embodiment, upon cooling of the heated core+shell precursor mixture to ambient temperature, the mixed LAP phosphate containing the activators Ce and Tb present in the flux material is epitaxially deposited on the core. In a molten state of the reaction mixture, some of the reactants may be trapped in the molten flux materials. Upon cooling of the heated core-shell mixture to ambient temperature, the trapped reactants may be extracted out from the flux materials and further deposited on the core. In one embodiment, the ambient temperature may include room temperature. The product core-shell phosphor is dispersed in the inorganic flux materials, and the dispersed product is then separated from the inorganic flux materials by washing with hot water and hot dilute acid. The filtered core-shell phosphor is washed with deionized water, and dried for a sufficient time, may be for overnight, in an oven to obtain the desired phosphor composition.

### EXAMPLES

Materials: Lithium tetra borate (Li₂B₄O₇) (98+%)were purchased from Sigma-Aldrich, MO, US. Diammonium hydrogen phosphate (DAP, (NH₄)₂HPO₄) (99%) and disodium hydrogen phosphate (Na₂HPO₄) (99%) were purchased from Merck, NJ, US. The LaPO₄ (27Ce/13Th) precursor was purchased from Rhodia, Courbevoie, France. Where required the raw materials were sieved through 325 mesh.

### Example 1

### Synthesis of Core-Shell Phosphor (LaPO₄:Ce,Tb shell on AlPO₄ Core)

The core−shell phosphor with LaPO₄:Ce,Tb on AlPO₄ powder was synthesized by a high temperature solid-state reaction in accordance with one embodiment of the invention. LaPO₄ (27Ce/13Tb) precursor (51.7158 g) and AlPO₄ (26.5157 g) were blended in a 250 ml Nalgene bottle along with about 7.3307 g Na₂HPO₄ and about 0.9535 gLi₂B₄O₇ (as fluxes). The reaction mixture was ball milled with 10¼″ zirconia media and 3½″ zirconia media for a duration of 15 minutes. After milling the milled powder was transferred to an alumina tray. The milled powder was placed in the tray and smaller alumina trays containing coconut charcoal were placed on top of the milled powder. Then the tray containing the milled powder and the small alumina trays with coconut charcoal was covered by another large tray and placed into the furnace. The tray was fired at a temperature of 960 ° C. for 5 hours in an atmosphere of pure nitrogen. At the end of the stipulated time the samples thus obtained were ground in a mortar and pestle and sieved through a 100 mesh sieve. The as-sieved powder was washed in hot H₂O (2×) for about two hours each. The washed powder was then ultrasonicated for 1.5 hours. The ultrasonicated powder was then treated with ethylenediaminetetraacetic acid (EDTA) solution about (1.4 g EDTA in 500 ml of water) for 2 hours. This was followed by treatment of the ultrasonicated powder with 1% nitric acid for two hours, followed by hot H₂O (2×) treatments for two hours. The washed ultrasonicated powder was then filtered and dried. After drying, the powder was placed into a 500 ml Nalgene bottle with 1000 grams of ¼″ zirconia media and shaken. The particle size distribution (PSD) was tested and the powder was found to be at a D50 of 6.3 microns). The powder was wet sieved through a 325 mesh screen and filtered and dried to obtain the final product.

### Characterization of Core-Shell Phosphor Particles:

The core-shell phosphor particles prepared were characterized by measuring particle size, morphology, and phase formation.

Core-Shell Phosphor Particle Size Measurement:

For determining particle size (particle diameter), core-shell phosphor samples from the examples described above were first subjected to a pre-analysis preparation step and then subjected to a particle size analyzer. The phosphor samples were dispersed in water to form a suspension, and the suspension was subjected to ultrasound treatment (130 W) for 45 sec. Ultrasound treatment improves the dispersion of the phosphor samples by deagglomeration and increases the uniformity. The particle diameter was measured using a laser particle size analyzer (Malvern Mastersizer 2000—Hydro 200S). The particle diameters were in the range from about 1 μm to about 15 μm.

### Core Shell Phosphor Crystal Structure:

The powder X-ray diffraction patterns were obtained using PANalytical diffractometer with Cu—K_{α} radiation in Bragg-Brentano geometry. The X-ray diffraction study was performed using the K_{α} line with copper (Cu) as an anticathode according to the Bragg-Brentano method. The core-shell phosphor particles were sieved through 325 mesh prior to the X-ray diffraction study. The X-ray diffraction patterns of the core-shell phosphor were compared with the reference phosphor. The core-shell phosphor showed uniform phase distribution with monazite structure.

### Quantum Efficiency Measurements:

Quantum efficiency and absorption measurements were carried out on the product core-shell phosphor powder. The product powder was pressed in an aluminum plaque and a spectra were recorded using a SPEX Flouorlog double spectrometer against a known internal LAP standard

The quantum efficiency (QE) determined for the product core-shell phosphor was found to be from 98 to 104% percent in comparison with that of the commercially available LAP phosphor employed as a standard

The material was also tested in linear fluorescent lamp (LFL) using established protocols and was found to be stable.

TABLE 1

| | Amount of AlPO₄ | |
|---|---|---|
| Reduction | (Wt. %) | Lumens/Watt |
| 30% | 18 | 77 |
| 50% | 34 | 107 |
| 70% | 54.5 | 95 |

The core-shell phosphor of Example 1 was tested in a linear fluorescent lamp (LFL) and a reduction a volume of the LAP phosphor with the corresponding amount of AlPO₄ in the core, are indicated in Table 1. Table 1 shows that the light output of the sample showing a 50% volume reduction of the LAP was as high as 107 Lumens/Watt for a 100 hour light out-put in a T8 linear fluorescent lamp.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is the Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. A core-shell phosphor composition comprising:
a core comprising at least one material selected from the group consisting of aluminum phosphate, gallium phosphate, calcium phosphate, magnesium phosphate, zinc phosphate and boron phosphate;
a shell at least partially enclosing the core, wherein the shell comprises a shell material having formula (I)
La_{1-x-y}CeₓTb_{y}PO₄ (I)
wherein, 0<x<0.95, and 0<y<0.5.

2. The composition according to claim 1, wherein the shell material has formula (I)
La_{1-x-y}CeₓTb_{y}PO₄ (I)
x is in a range from about 0.05 to 0.50, y is in a range from about 0.05 to about 0.4, and (x+y) is less than about 1.

3. The composition according to claim 1, wherein the shell material consists essentially of La_{0.6}Ce_{0.27}Th_{0.13}PO₄.

4. The composition according to claim 1, wherein the shell has a thickness in a range from about 0.25 μm to 5 μm.

5. The composition according to claim 1, wherein the core-shell phosphor comprises a particulate structure with a longest dimension in a range from about 0.5 μm to about 20 μm.

6. The composition according to claim 1, wherein the core comprises aluminum phosphate.

7. The composition according to claim 1, wherein the core has a thickness in a range from about 0.5 μm to 5 μm.

8. The composition according to claim 1, wherein the core comprises a particulate structure with a longest dimension in a range from about 0.2 μm to about 5 μm.

9. The composition according to claim 1, wherein the shell substantially encloses the core.

10. The composition according to claim 1, wherein an atom percent of La in the shell is in a range from about 0% to about 60%.

11. The composition according to claim 1, wherein an atom percent of Tb in the shell is in a range from about 1% to about 20%.

12. The composition according to claim 1, wherein an atom percent of Ce in the shell is in a range from about 10% to about 100%.

13. The composition according to claim 1, the core-shell phosphor has a relative quantum efficiency in a range from about 90% to about 105%.

14. A method of making a core-shell phosphor, the method comprising:
(a) mixing at least one core material selected from the group consisting of aluminum phosphate, gallium phosphate, calcium phosphate, magnesium phosphate, zinc phosphate and boron phosphate with a shell precursor mixture comprising at least one compound of La, at least one compound of Ce, and at least one compound of Tb to form a core+shell precursor mixture;
(b) heating the core+shell precursor mixture to a temperature in a range from about 800° C. to about 1200° C. with an inorganic flux material to provide a heated core+shell precursor mixture;
(c) cooling the heated core+shell precursor mixture to ambient temperature to provide a product core-shell phosphor dispersed in the inorganic flux material; and
(d) separating the product core-shell phosphor from the inorganic flux material.

15. The method according to claim 14, wherein the compound of La, the compound of Ce, and the compound of Tb, are independently at each occurrence, selected from the group consisting of oxides, nitrates, carbonates, acetates, phosphates, oxalates, and combinations thereof.

16. The method according to claim 14, wherein the shell precursor mixture further comprises diammonium phosphate (DAP).

17. The method according to claim 14, wherein the shell precursor mixture comprises DAP, La₂O₃, CeO₂, and Tb₄O₇.

18. The method according to claim 13, wherein the inorganic flux material is a mixture of disodium hydrogen phosphate, and lithium tetra borate.

19. The method according to claim 14, further comprising heating the core+shell precursor mixture with an inorganic flux material in presence of a reductant.

20. The method according to claim 19, wherein the reductant comprises hydrogen, nitrogen, or charcoal.

21. The method according to claim 19, wherein the reductant is hydrogen.

22. A core-shell phosphor composition comprising:
a core comprising aluminum phosphate;
a shell at least partially enclosing the core, wherein the shell comprises a shell material having formula (I)
La_{1-x-y}CeₓTb_{y}PO₄ (I)
wherein, 0<x<0.95, and 0<y<0.5.

23. A light source comprising a core-shell phosphor composition comprising:
a core comprising aluminum phosphate;
a shell at least partially enclosing the core, wherein the shell comprises a shell material having formula (I)
La_{1-x-y}CeₓTb_{y}PO₄ (I)
wherein, 0<x<0.95, and 0<y<0.5.
